(19) United States
(12) Patent Application Publication
(10) Pub. No.: US 2009/0292781 A1
(43) Pub. Date: Nov. 26, 2009

(54) METHOD FOR FILTERING E-MAIL AND MAIL FILTERING SYSTEM THEREOF

(75) Inventors: Wei-Chung Teng, Taipei (TW); Wei-Lun Teng, Taipei (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: National Taiwan University of Science and Technology, Taipei (TW)

(21) Appl. No.: 12/170,447

(22) Filed: Jul. 10, 2008

(30) Foreign Application Priority Data
May 23, 2008 (TW) 97119168

(51) Int. Cl. G06F 15/16

(52) U.S. Cl. 709/206

(57) ABSTRACT

A method for filtering e-mails and a mail filtering system thereof are provided. In the present invention, two filters are used to filter a first mail class and a second mail class respectively. And these filters are connected in serial or in parallel to execute a filtration of the e-mail. Accordingly, a structure of the filters can be more flexible, so as to cope with different requirements of a user, and a misjudgement rate of the e-mails can be reduced.

### CROSS-REFERENCE TO RELATED APPLICATION

This application claims the priority benefit of Taiwan application serial no. 97119168, filed on May 23, 2008. The entirety of the above-mentioned patent application is hereby incorporated by reference herein and made a part of specification.

### BACKGROUND OF THE INVENTION

1. Field of the Invention

The present invention relates to an e-mail management mechanism. More particularly, the present invention relates to a method for filtering e-mails with at least two filters, and a mail filtering system thereof.

2. Description of Related Art

With advent of an electronic era, e-mails are increasingly used for transmitting messages, and the e-mail has become an indispensable communication method in people's daily life. Since only a dialing cost is required to be paid for transmitting the e-mail via the Internet, a lot of cost is saved compared to a conventional paper mail. Consequently, such transmission feature of the e-mail can be utilized by some advertisers to send advertisement e-mails all around, which may cause inconvenience to users. Therefore, a lot of e-mail service providers develop a spam mail filtering mechanism for blocking the spam mails such as advertisement mails, etc.

Generally, a spam mail filtering software applies a filter for filtering spam mails. A threshold value is generally provided for setting a stringency of the filter, and if the stringency of the filter is too strict that a lot of normal mails are misjudged to be spam mails, the threshold value can be lowered to reduce misjudgement of the normal mails, and vice versa. However, such method may lead to a low identification rate for the spam mails.

A present e-mail filtering method has a dilemma during spam mail blocking, namely, the more stringent the filter is, the more normal mails are misjudged to be the spam mails. One of the important reasons of such situation is that the users have different standards for determining the normal mails. For example, some advertisement mails regarded as spam mails by some users can be the mails having useful information for the other users. In such case, a widely used rule of the normal mail cannot be predefined to the filter for each user, so that possibility of misjudging the normal mail cannot be pre-estimated. Some of the present spam mail filtering software apply a user feedback mechanism to help the filter identifying the normal mails and the spam mails. However, these spam mail filtering software simultaneously compare the features of the normal mail and the spam mail to the e-mail to be filtered, so as to generate a synthetic score. In this case, regardless of how the threshold value being adjusted, misjudgement rates for the spam mails and the normal mails cannot be simultaneously reduced.

### SUMMARY OF THE INVENTION

The present invention is directed to a method for filtering e-mails, by which whether the e-mail is a spam mail or a normal mail can be judged, so as to reduce a misjudgement rate.

The present invention is directed to a mail filtering system, which applies a filter for filtering normal mails, and applies another filter for filtering spam mails, so as to provide a more integral mail filtering operation.

The present invention provides a method for filtering e-mails. First, an e-mail is received. Next, a first filter extracts a first characteristic data of the e-mail to obtain a first score, and determines whether to classify the e-mail to a first mail class according to the first score. When the first filter judges not to classify the e-mail to the first mail class, a second filter then extracts a second characteristic data of the e-mail to obtain a second score, and determines whether to classify the e-mail to a second mail class according to the second score. Finally, when the second filter judges not to classify the e-mail to the second mail class, the e-mail is then classified to the first mail class.

In an embodiment of the present invention, the step of judging whether to classify the e-mail to the first mail class according to the first score includes judging whether the first score is greater than or equal to a first threshold value, so as to classify the e-mail to the first mail class if the first score is greater than or equal to the first threshold value, and not classify the e-mail to the first mail class if the first score is less than the first threshold value.

In an embodiment of the present invention, the step of judging whether to classify the e-mail to the second mail class according to the second score includes judging whether the second score is greater than or equal to a second threshold value, so as to classify the e-mail to the second mail class if the second score is greater than or equal to the second threshold value, and classify the e-mail to the first mail class if the second score is less than the second threshold value.

The present invention provides a method for filtering e-mails. First, after the e-mail is received, a first filter extracts a first characteristic data of the e-mail to obtain a first score, and determines whether to classify the e-mail to a first mail class according to the first score. Next, a second filter extracts a second characteristic data of the e-mail to obtain a second score, and determines whether to classify the e-mail to a second mail class according to the second score. Finally, the e-mail is classified to the first mail class or the second mail class according to the first score, the second score and a threshold value.

In an embodiment of the present invention, the method of classifying the e-mail to the first mail class or the second mail class according to the first score, the second score and the threshold value includes following steps. First, the first score and the second score are respectively operated with a first weight value and a second weight value, so as to respectively obtain a first weighted score and a second weighted score. Next, the first weighted score, the second weighted score and the threshold value are compared, and if the first weighted score is greater than the threshold value, the e-mail is classified to the first mail class; conversely, if the second weighted score is greater than the threshold value, the e-mail is classified to the second mail class.

In an embodiment of the present invention, the method of classifying the e-mail to the first mail class or the second mail class according to the first score, the second score and the threshold value further includes integrating the first score and the second score to obtain a third score, so as to compare the third score to the threshold value. Wherein, if the third score is less than the threshold value, the e-mail is classified to the first mail class; conversely, if the third score is greater than or equal to the threshold value, the e-mail is classified to the second mail class.

The present invention provides a mail filtering system including a mail transceiving unit, a first filter and a second filter. The mail transceiving unit is used for receiving an e-mail. The first filter is coupled to the mail transceiving unit for extracting a first characteristic data of the e-mail to obtain a first score, so as to determine whether to classify the e-mail to a first mail class according to the first score. The second filter is coupled to the mail transceiving unit for extracting a second characteristic data of the e-mail to obtain a second score, so as to determine whether to classify the e-mail to a second mail class according to the second score. Wherein, the mail filtering system determines to classify the e-mail to the first mail class or the second mail class according to the first score, the second score and at least a threshold value.

In an embodiment of the present invention, the second filter and the first filter are connected in serial. Moreover, the threshold value includes a first threshold value and a second threshold value. The first filter determines whether to classify the e-mail to the first mail class according to the first score and the first threshold value, and if the first filter determines not to classify the e-mail to the first mail class, the second filter then determines whether to classify the e-mail to the second mail class according to the second score and the second threshold value, so that if the second filter determines not to classify the e-mail to the second mail class, the e-mail is classified to the first mail class.

In an embodiment of the present invention, if the second filter and the first filter are connected in serial, the first filter includes a first calculation module and a comparison module, and the second filter includes a second calculation module and a second comparison module. The first calculation module is used for calculating the first score according to the first characteristic data. The first comparison module is used for judging whether the first score is greater than or equal to the first threshold value, so as to classify the e-mail to the first mail class when the first score is greater than or equal to the first threshold value, and not classify the e-mail to the first mail class when the first score is less than the first threshold value.

Moreover, the second calculation module is used for calculating the second score according to the second characteristic data. The second comparison module is used for judging whether the second score is greater than or equal to the second threshold value, so as to classify the e-mail to the second mail class when the second score is greater than or equal to the second threshold value, and classify the e-mail to the first mail class when the second score is less than the second threshold value.

In an embodiment of the present invention, the second filter and the first filter are connected in parallel, and the mail transceiving unit further includes an integration classification module coupled to the first filter and the second filter for classifying the e-mail to the first mail class or the second mail class according to the first score, the second score and the threshold value.

In an embodiment of the present invention, if the second filter and the first filter are connected in parallel, the first filter includes a first calculation module and a first weighted module, and the second filter includes a second calculation module and a second weighted module. The first calculation module is used for calculating the first score according to the first characteristic data. The first weighted module is used for operating the first score with a first weight value, so as to obtain a first weighted score.

Moreover, the second calculation module is used for calculating the second score according to the second characteristic data. The second weighted module is used for operating the second score with a second weight value, so as to obtain a second weighted score. The integration classification module compares the first weighted score, the second weighted score and the threshold value, and classifies the e-mail to the first mail class when the first weighted score is greater than the threshold value, or classifies the e-mail to the second mail class when the second weighted score is greater than the threshold value.

In an embodiment of the present invention, one of the first mail class and the second mail class is a normal mail class, and another one is a spam mail class.

In the present invention, at least two filters are applied to respectively filter the first mail class (for example, the normal mail class) and the second mail class (for example, the spam mail class), and these filters are connected in serial or in parallel to execute a filtration of the e-mail. Accordingly, a structure of the filters can be more flexible, so as to cope with different requirements of a user, and a misjudgement rate of the e-mails can be reduced.

In order to make the aforementioned and other objects, features and advantages of the present invention comprehensible, a preferred embodiment accompanied with figures is described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1A and FIG. 1B are schematic diagrams illustrating a mail filtering system according to a first embodiment of the present invention.

FIG. 2 is a block diagram illustrating a mail filtering system according to a second embodiment of the present invention.

FIG. 3 is a flowchart illustrating a method for filtering e-mails according to the second embodiment of the present invention.

FIG. 4 is a block diagram illustrating a mail filtering system according to a third embodiment of the present invention.

FIG. 5 is a flowchart illustrating a method for filtering e-mails according to the third embodiment of the present invention.

### DESCRIPTION OF EMBODIMENTS

A conventional mail filtering system applies only one filter to filter spam mails. However, such conventional filtering system cannot simultaneously reduce a chance of misjudging normal mails to be the spam mails, and a chance of misjudging the spam mails to be the normal mails. Therefore, the present invention provides a method for filtering e-mails and a system thereof for reducing a misjudgement rate of the e-mails. To fully convey the concept of the present invention, embodiments are provided below for describing the present invention in detail.

For simplicity's sake, in the following embodiments, the e-mails are divided into two categories of the normal mails and the spam mails, and two filters are applied for respectively filtering the normal mails and the spam mails. Moreover, inboxes of a mailbox include a normal mail inbox (i.e. a normal mail class) and a spam mail inbox (i.e. a spam mail class) for respectively storing the normal mails and the spam mails.

### First Embodiment

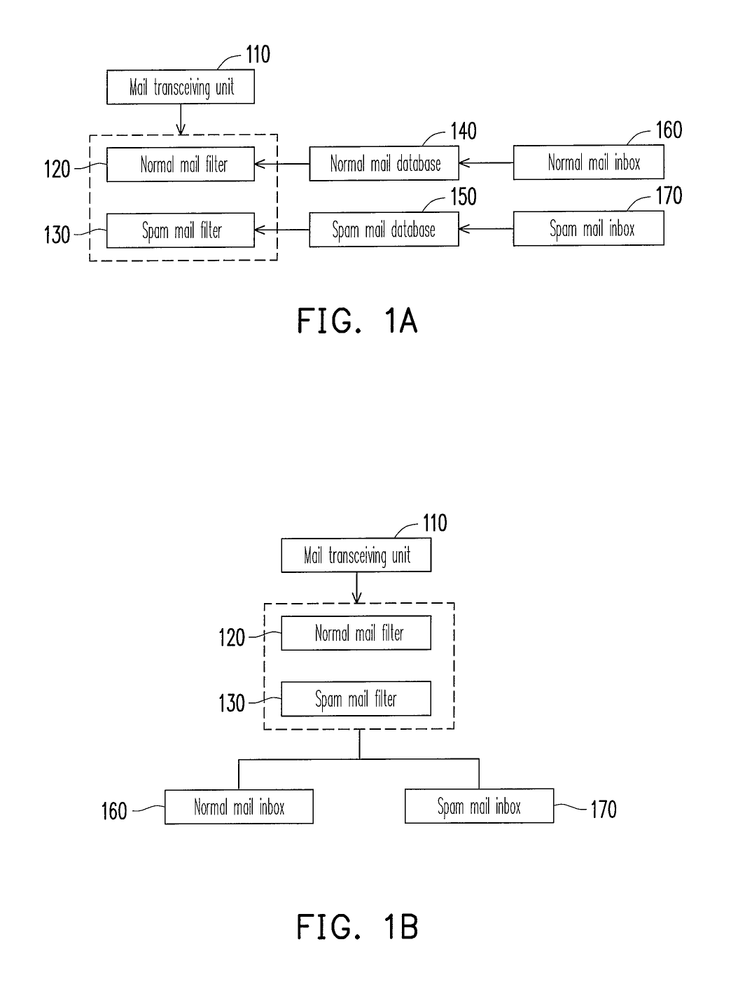

FIG. 1A and FIG. 1B are schematic diagrams illustrating a mail filtering system according to a first embodiment of the present invention. Referring to FIG. 1A, a plenty of normal mails and spam mails are used for respectively training a normal mail filter 120 and a spam mail filter 130, so as to establish their own mail filtering rules.

Assuming complete e-mail classification operations are performed in the mailbox, and all of the e-mails are correctly classified to a normal mail inbox 160 and a spam mail inbox 170. Then, the normal mail inbox 160 and the spam mail inbox 170 are respectively used for training the normal mail filter 120 and the spam mail filter 130.

For example, first, related characteristic data are respectively fetched from the normal mail inbox 160 and the spam mail inbox 170, and are respectively stored into a normal mail database 140 and a spam mail database 150. Next, the normal mail filter 120 receives the characteristic data of the normal mail from the normal mail database 140 to perform the training, so as to establish a filtering rule for the normal mail, and therefore the e-mail received by the mail transceiving unit 110 can be classified according to the filtering rule of the normal mail. Conversely, the spam mail filter 130 receives the characteristic data of the spam mail from the spam mail database 150 to perform the training, so as to establish a filtering rule for the spam mail.

Next, referring to FIG. 1B, the normal mail filter 120 and the spam mail filter 130 are utilized for classifying the e-mail received by the mail transceiving unit 110, so as to classify the e-mail to the normal mail inbox 160 or the spam mail inbox 170.

In addition, the normal mail filter 120 and the spam mail filter 130 can be connected in serial or in parallel for filtering the e-mails. In the following content, embodiments thereof are provided for detailed description.

### Second Embodiment

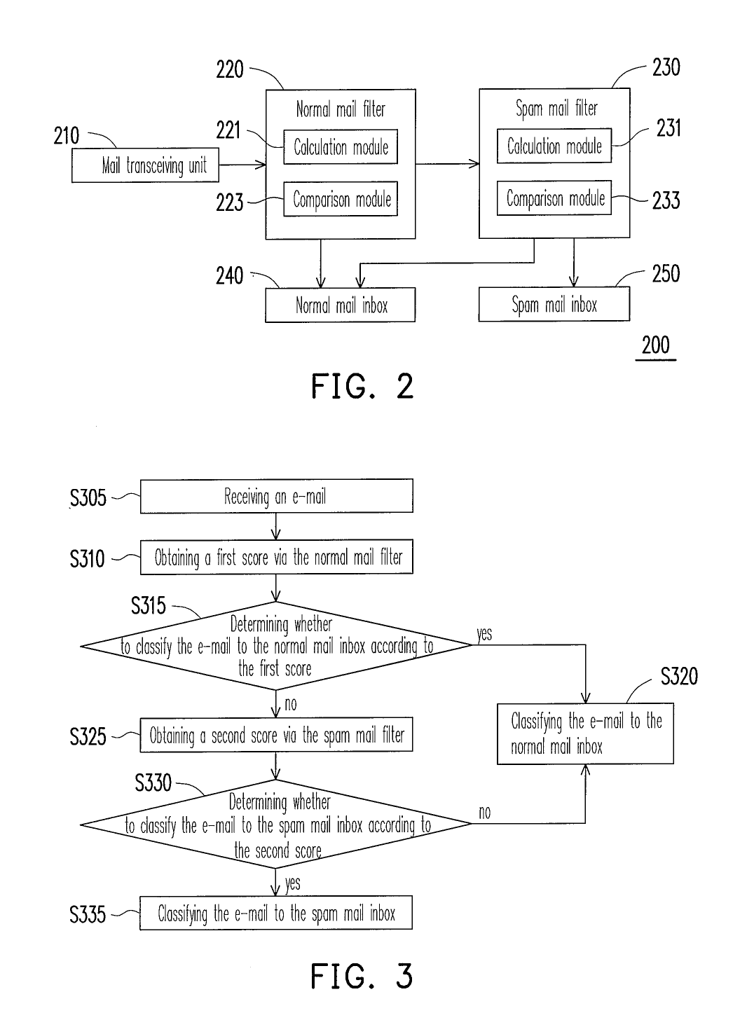

FIG. 2 is a block diagram illustrating a mail filtering system according to a second embodiment of the present invention. Referring to FIG. 2, the mail filtering system 200 includes a mail transceiving unit 210, a normal mail filter 220, a spam mail filter 230, a normal mail inbox 240 and a spam mail inbox 250. Wherein, the normal mail filter 220 is coupled between the mail transceiving unit 210 and the spam mail filter 230, namely, the normal mail filter 220 and the spam mail filter 230 are connected in serial. The normal mail inbox 240 is coupled to the normal mail filter 220 and the spam mail filter 230, and the spam mail inbox 250 is coupled to the spam mail filter 230.

The mail transceiving unit 210 receives an e-mail, and transmits the e-mail to the normal mail filter 220. The normal mail filter 220 extracts characteristic data related to the normal mail from the e-mail, so as to obtain a first score, and judges whether to classify the e-mail to the normal mail inbox 240 according to the first score. The spam mail filter 230 extracts characteristic data related to the spam mail from the e-mail, so as to obtain a second score, and judges whether to classify the e-mail to the spam mail inbox 250 according to the second score.

To be specific, the normal mail filter 220 includes a calculation module 221 and a comparison module 223. The calculation module 221 calculates the first score according to the characteristic data related to the normal mail. The comparison module 223 judges whether the first score is greater than or equal to a first threshold value, wherein if the first score is greater than or equal to the first threshold value, the e-mail is classified to the normal mail inbox 240, and if the first score is less than the first threshold value, the e-mail is not classified to the normal mail inbox 240, and is re-filtered by the spam mail filter 230.

Moreover, the spam mail filter 230 includes a calculation module 231 and a comparison module 233. The calculation module 231 calculates the second score according to the characteristic data related to the spam mail. The comparison module 233 judges whether the second score is greater than or equal to a second threshold value, wherein if the second score is greater than or equal to the second threshold value, the e-mail is classified to the spam mail inbox 250, and if the second score is less than the second threshold value, the e-mail is classified to the normal mail inbox 240.

In brief, in the present embodiment, when the normal mail filter 220 judges that the e-mail is not the normal mail, the spam mail filter 230 again judges whether the e-mail is the spam mail. In the other embodiments, the spam mail filter 230 may also be coupled between the mail transceiving unit 210 and the normal mail filter 220, and the spam mail inbox 250 is coupled to the normal mail filter 220 and the spam mail filter 230, while the normal mail inbox 240 is coupled to the normal mail filter 220. By such means, the spam mail filter 230 first judges whether the e-mail is the spam mail. Next, if the e-mail is judged to be not the spam mail, the normal mail filter 220 then judges whether the e-mail is the normal mail.

In the following content, a method for filtering the e-mail is described in detail with reference of the aforementioned mail filtering system 200. FIG. 3 is a flowchart illustrating a method for filtering e-mails according to the second embodiment of the present invention. Referring to FIG. 2 and FIG. 3, first, in step S305, the mail transceiving unit 310 receives an e-mail.

Next, in step S310, the first score of the e-mail is obtained via the normal mail filter 220. Namely, the calculation module 221 extracts the characteristic data related to the normal mail from the e-mail, so as to calculate the first score. Next, in step S315, the comparison module 223 judges whether the e-mail is the normal mail according to the first score. If yes, in step S320, the e-mail is classified to the normal mail inbox 240. Conversely, if not, in step S325, the e-mail is again filtered by the spam mail filter 230.

For example, the comparison module 223 judges whether the first score is greater than or equal to the first threshold value. If the first score is greater than or equal to the first threshold value, it represents the e-mail is the normal mail, and as shown in the step S320, the e-mail is classified to the normal mail inbox 240. Conversely, if the first score is less than the first threshold value, it represents the e-mail probably is the spam mail, and in the step S325, the e-mail is again filtered by the spam mail filter 230.

In the step S325, the spam mail filter 230 extracts the characteristic data related to the normal mail from the e-mail, so as to obtain the second score. Namely, the calculation module 231 extracts the characteristic data related to the normal mail from the e-mail and calculates the second score. Next, in step S330, the comparison module 233 judges whether the e-mail is the spam mail according to the second score. If yes, in step S335, the e-mail is classified to the spam mail inbox 335. Conversely, if not, it represents the e-mail is not the spam mail, and in step S320, the e-mail is classified to the normal mail inbox 240.

For example, the comparison module 233 judges whether the second score is greater than or equal to the second threshold value. If the second score is greater than or equal to the second threshold value, in the step S335, the e-mail is classified to the spam mail inbox 250. Conversely, if the second score is less than the second threshold value, in the step S320, the e-mail is classified to the normal mail inbox 240.

Moreover, the first threshold value and the second threshold value can be the same or different, which is not limited by the present invention.

In summary, according to the above embodiment, the e-mail can be doubly confirmed, by which the e-mail is first filtered by a filter with a relatively high reliability, and then is confirmed by another filter. By such means, a chance of misjudging the normal mail to be the spam mail can be reduced, and a chance of misjudging the spam mail to be the normal mail can also be reduced, so that a better mail filtering effect is achieved. In addition, the first threshold value and the second threshold value can be further adjusted according to actual requirements, so that classification results of the e-mails can be more accurate.

### Third Embodiment

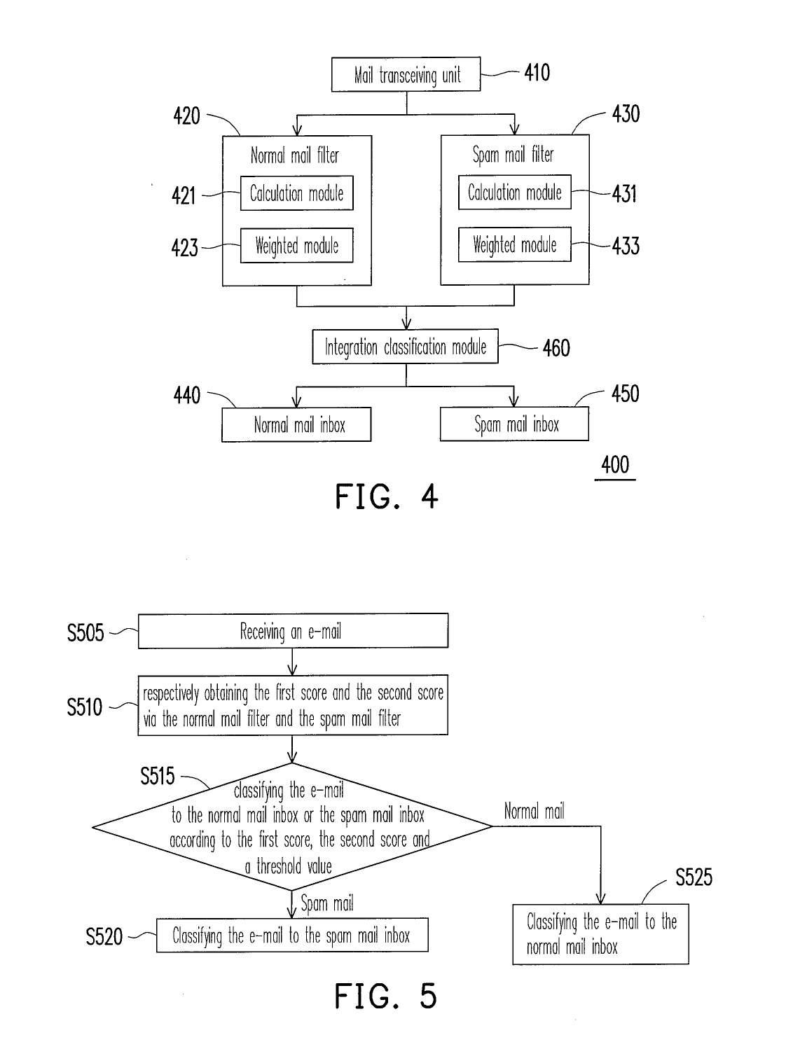

FIG. 4 is a block diagram illustrating a mail filtering system according to a third embodiment of the present invention. Referring to FIG. 4, the mail filtering system 400 includes a mail transceiving unit 410, a normal mail filter 420, a spam mail filter 430, a normal mail inbox 440, a spam mail inbox 450 and integration classification module 460. The normal mail filter 420 and the spam mail filter 430 are respectively coupled between the mail transceiving unit 410 and the integration classification module 460, namely, the normal mail filter 420 and the spam mail filter 430 are connected in parallel. The normal mail inbox 440 and the spam mail inbox 450 are respectively coupled to the integration classification module 460.

The mail transceiving unit 410 receives an e-mail and simultaneously transmits the e-mail to the normal mail filter 420 and the spam mail filter 430. The normal mail filter 420 extracts the characteristic data related to the normal mail from the e-mail to obtain a first score. The spam mail filter 430 extracts the characteristic data related to the spam mail from the e-mail to obtain a second score. The integration classification module 460 determines to classify the e-mail to the normal mail inbox 440 or the spam mail inbox 450 according to the first score, the second score and a threshold value.

To be specific, the normal mail filter 420 includes a calculation module 421 and a weighted module 423. The calculation module 421 calculates the first score according to the characteristic data related to the normal mail. The weighted module 423 operates the first score with a first weight value to obtain a first weighted score. Moreover, the spam mail filter 430 includes a calculation module 431 and a weighted module 433. The calculation module 431 calculates the second score according to the characteristic data related to the spam mail. The weighted module 433 operates the first score with a second weight value to obtain a second weighted score.

The integration classification module 460 determines to classify the e-mail to the normal mail inbox 440 or the spam mail inbox 450 according to the first weighted score, the second weighted score and the threshold value. For example, if the first weighted score is greater than the threshold value, the integration classification module 460 classifies the e-mail to the normal mail inbox 440; conversely, if the second weighted score is greater than the threshold value, the integration classification module 460 classifies the e-mail to the spam mail inbox 450.

In the following content, a method for filtering the e-mail is described with reference of the aforementioned mail filtering system 400. FIG. 5 is a flowchart illustrating a method for filtering e-mails according to the third embodiment of the present invention. Referring to FIG. 4 and FIG. 5, first, in step S505, the mail transceiving unit 410 receives an e-mail.

Next, in step S510, the normal mail filter 420 and the spam mail filter 430 respectively obtain the first score and the second score. In detail, the mail transceiving unit 410 simultaneously transmits the e-mail to the normal mail filter 420 and the spam mail filter 430. The normal mail filter 420 extracts the characteristic data related to the normal mail from the e-mail via the calculation module 421, so as to calculate the first score. The spam mail filter 430 extracts the characteristic data related to the spam mail from the e-mail via the calculation module 431, so as to calculate the second score.

Next, in step S515, the integration classification module 460 determines to classify the e-mail to the normal mail inbox 440 or the spam mail inbox 450 according to the first score, the second score and a threshold value. If the integration classification module 460 judges the e-mail to be the normal mail, in step S525, the e-mail is then classified to the normal mail inbox 440; and if the integration classification module 460 judges the e-mail to be the spam mail, in step S520, the e-mail is then classified to the spam mail inbox 450.

For example, in the present embodiment, the weighted module 423 operates the first score with the first weight value to obtain the first weighted score, and the weighted module 433 operates the second score with the second weight value to obtain the second weighted score. Next, the integration classification module 460 compares the first weighted score and the second weighted score with the threshold value. If the first weighted score is greater than the threshold value, as shown in the step S525, the integration classification module 460 classifies the e-mail to the normal mail inbox 440. Conversely, if the second weighted score is greater than the threshold value, as shown in the step S520, the integration classification module 460 classifies the e-mail to the spam mail inbox 450.

Moreover, in the other embodiments, the integration classification module 460 may further integrate the first score and the second score to be a third score, and compare the third score to the threshold value. For example, if the third score is less than the threshold value, the e-mail is classified to the normal mail inbox 440; conversely, if the third score is greater than or equal to the threshold value, the e-mail is classified to the spam mail inbox 450.

It should be noted that in the aforementioned embodiments, number of the filters is not limited to two, which may be suitably increased by connecting more filters in parallel or in serial according to actual requirements, so as to mitigate a chance of misjudging the spam mail to be the normal mail, or misjudging the normal mail to be the spam mail.

For example, if the first weighted score and the second weighted score are all greater than the threshold value or less than the threshold value, the e-mail then can be filtered according to the method of the second embodiment. For example, the first weighted score and the second weighted score are compared, and then the filter corresponding to the relatively greater weighted score is considered to be a filter with a relatively high reliability. Next, after the e-mail is filtered by the filter with the relatively high reliability, if the filtration is failed, the e-mail is again filtered by another filter.

In summary, in the present invention, at least two filters are applied to respectively filter the normal mail and the spam mail, and these filters are connected in serial or in parallel to execute a filtration of the e-mail. Accordingly, a structure of the filters can be more flexible, so as to cope with different requirements of a user, and a misjudgement rate of the e-mails can be reduced.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A method for filtering e-mails, comprising:
receiving an e-mail;
extracting a first characteristic data of the e-mail via a first filter to obtain a first score, and determining whether to classify the e-mail to a first mail class according to the first score;
if the first filter determines not to classify the e-mail to the first mail class, extracting a second characteristic data of the e-mail via a second filter to obtain a second score, and determining whether to classify the e-mail to a second mail class according to the second score; and
if the second filter determines not to classify the e-mail to the second mail class, classifying the e-mail to the first mail class.

2. The method for filtering e-mails as claimed in claim 1, wherein steps of determining whether to classify the e-mail to the first mail class according to the first score comprise:
judging whether the first score is greater than or equal to a first threshold value;
classifying the e-mail to the first mail class, if the first score is greater than or equal to the first threshold value; and
not classifying the e-mail to the first mail class, if the first score is less than the first threshold value.

3. The method for filtering e-mails as claimed in claim 1, wherein the step of determining whether to classify the e-mail to the second mail class according to the second score comprises:
judging whether the second score is greater than or equal to a second threshold value, so as to classify the e-mail to the second mail class if the second score is greater than or equal to the second threshold value.

4. The method for filtering e-mails as claimed in claim 3, wherein after the step of judging whether the second score is greater than or equal to the second threshold value, further comprises:
classifying the e-mail to the first mail class if the second score is less than the second threshold value.

5. The method for filtering e-mails as claimed in claim 1, wherein one of the first mail class and the second mail class is a normal mail class, and another one is a spam mail class.

6. A method for filtering e-mails, comprising:
receiving an e-mail;
extracting a first characteristic data of the e-mail via a first filter to obtain a first score, and determining whether to classify the e-mail to a first mail class according to the first score;
extracting a second characteristic data of the e-mail to obtain a second score, and determining whether to classify the e-mail to a second mail class according to the second score; and
classifying the e-mail to the first mail class or the second mail class according to the first score, the second score and a threshold value.

7. The method for filtering e-mails as claimed in claim 6, wherein steps of classifying the e-mail to the first mail class or the second mail class according to the first score, the second score and the threshold value comprise:
respectively operating the first score and the second score with a first weight value and a second weight value, so as to respectively obtain a first weighted score and a second weighted score;
comparing the first weighted score, the second weighted score and the threshold value;
classifying the e-mail to the first mail class if the first weighted score is greater than the threshold value; and
classifying the e-mail to the second mail class if the second weighted score is greater than the threshold value.

8. The method for filtering e-mails as claimed in claim 6, wherein steps of classifying the e-mail to the first mail class or the second mail class according to the first score, the second score and the threshold value further comprise:
integrating the first score and the second score to obtain a third score, so as to compare the third score to the threshold value;
classifying the e-mail to the first mail class if the third score is less than the threshold value; and
classifying the e-mail to the second mail class if the third score is greater than or equal to the threshold value.

9. The method for filtering e-mails as claimed in claim 6, wherein one of the first mail class and the second mail class is a normal mail class, and another one is a spam mail class.

10. A mail filtering system, comprising:
a mail transceiving unit, for receiving an e-mail;
a first filter, coupled to the mail transceiving unit for extracting a first characteristic data of the e-mail to obtain a first score, and judging whether to classify the e-mail to a first mail class according to the first score; and
a second filter, coupled to the mail transceiving unit for extracting a second characteristic data of the e-mail to obtain a second score, and judging whether to classify the e-mail to a second mail class according to the second score,
wherein the mail filtering system determines to classify the e-mail to the first mail class or the second mail class according to the first score, the second score and at least a threshold value.

11. The mail filtering system as claimed in claim 10, wherein the second filter and the first filter are connected in serial, and the threshold value comprises a first threshold value and a second threshold value,
wherein first filter determines whether to classify the e-mail to the first mail class according to the first score and the first threshold value, and when the first filter determines not to classify the e-mail to the first mail class, the second filter then determines whether to classify the e-mail to the second mail class according to the second score and the second threshold value, so that when the second filter determines not to classify the e-mail to the second mail class, the e-mail is then classified to the first mail class.

12. The mail filtering system as claimed in claim 11, wherein the first filter comprises:
a first calculation module, for calculating the first score according to the first characteristic data; and
a first comparison module, for judging whether the first score is greater than or equal to the first threshold value, so as to classify the e-mail to the first mail class when the first score is greater than or equal to the first threshold value, and not classify the e-mail to the first mail class when the first score is less than the first threshold value.

13. The mail filtering system as claimed in claim 11, wherein the second filter comprises:
a second calculation module, for calculating the second score according to the second characteristic data; and
a second comparison module, for judging whether the second score is greater than or equal to the second threshold value, so as to classify the e-mail to the second mail class when the second score is greater than or equal to the second threshold value, and classify the e-mail to the first mail class when the second score is less than the second threshold value.

14. The mail filtering system as claimed in claim 10, wherein the second filter and the first filter are connected in parallel, and the mail transceiving unit further comprises:
an integration classification module, coupled to the first filter and the second filter for classifying the e-mail to the first mail class or the second mail class according to the first score, the second score and the threshold value.

15. The mail filtering system as claimed in claim 14, wherein the first filter comprises:
a first calculation module, for calculating the first score according to the first characteristic data; and
a first weighted module, for operating the first score with a first weight value, so as to obtain a first weighted score.

16. The mail filtering system as claimed in claim 15, wherein the second filter comprises:
a second calculation module, for calculating the second score according to the second characteristic data; and
a second weighted module, for operating the second score with a second weight value, so as to obtain a second weighted score,
wherein the integration classification module compares the first weighted score, the second weighted score and the threshold value, and classifies the e-mail to the first mail class when the first weighted score is greater than the threshold value, or classifies the e-mail to the second mail class when the second weighted score is greater than the threshold value.

17. The mail filtering system as claimed in claim 10, wherein one of the first mail class and the second mail class is a normal mail class, and another one is a spam mail class.
